(19) United States
(12) Patent Application Publication
(10) Pub. No.: US 2026/0066159 A1
(43) Pub. Date: Mar. 5, 2026

(54) METHOD FOR MANUFACTURING SHUNT RESISTOR

(71) Applicant: YAGEO CORPORATION, Kaohsiung City (TW)

(72) Inventors: Shen-Li HSIAO, Kaohsiung City (TW); Suneesh Meledath Valiyaveettil, Kaohsiung City (TW); Seerangan Iyyamperumal, Kaohsiung City (TW)

(21) Appl. No.: 18/926,337

(22) Filed: Oct. 25, 2024

(30) Foreign Application Priority Data
Aug. 28, 2024 (TW) 113132398

(51) Int. Cl. H01C 17/245; H01C 17/28

(52) U.S. Cl. CPC H01C 17/245; H01C 17/288

(57) ABSTRACT

A method for manufacturing a shunt resistor is provided. In this method, a resistance piece is attached to an insulating carrier film. An electroplating operation is performed to form an electrode material layer on a surface of the resistance piece. A first mechanical dicing operation is performed to respectively dice the electrode material layer and the resistance piece into plural electrode layers and plural resistance layers to form plural strip structures. Each of the strip structures includes one electrode layer and one resistance layer. A second mechanical dicing operation is performed on the strip structures to dice the electrode layer on each of the strip structures into a first electrode and a second electrode. A third mechanical dicing operation is performed on each of the strip structures to separate each of the strip structures into plural shunt resistors. A trimming operation is performed on each of the shunt resistors.

### CROSS-REFERENCE TO RELATED APPLICATION

This application claims priority to Taiwan Application Serial Number 113132398, filed August 28, 2024, which is herein incorporated by reference.

### BACKGROUND

### Field of Invention

The present disclosure relates to a technology for manufacturing a passive device, and more particularly, to a method for manufacturing a shunt resistor.

### Description of Related Art

Traditionally, shunt resistors are manufactured by using a laser welding method or an electron beam welding method to combine a strip-shaped copper material and a strip-shaped alloy material to form a strip-shaped stacked structure. Then, a punching and pelletizing operation is performed on the strip-shaped stacked structure to form individual shunt resistors. In the shunt resistor, the copper is the terminal electrode and the alloy is the main material of the resistor.

However, the apparatus costs of the laser welding method and the electron beam welding method are both very high. In addition, the heat generated during welding causes differences in the electrical stability of the shunt resistor products. Moreover, due to the welding width, the shunt resistor cannot be miniaturized. For example, the shunt resistor cannot be smaller than the SMD 2512 type.

Currently, in order to achieve miniaturization of the shunt resistors, a pressure and heating method is used to bond a copper layer and an alloy layer that are in a strip shape or a plate shape to form a strip-shaped stacked structure or a plate-shaped stacked structure. Then, a portion of the copper layer is removed to expose a portion of the alloy layer by using a mechanical grinding method. Subsequently, a punching and pelletizing operation is performed on the strip-shaped stacked structure or the plate-shaped stacked structure to form individual shunt resistors.

However, such a method requires a large-scale apparatus to pressurize the copper layer and the alloy layer, and a large-scale apparatus to perform the punching and pelletizing operation. Therefore, the initial cost investment is high, and the material loss rate during pre-production operations is high.

### SUMMARY

One objective of the present disclosure is to provide a method for manufacturing a shunt resistor, which can achieve miniaturization of the shunt resistor with low equipment cost.

According to the above objective, the present disclosure provides a method for manufacturing a shunt resistor. In this method, a resistance piece is attached to an insulating carrier film. An electroplating operation is performed to form an electrode material layer on a surface of the resistance piece. A first mechanical dicing operation is performed to respectively dice the electrode material layer and the resistance piece into plural electrode layers and plural resistance layers to form plural strip structures. Each of the strip structures includes one of the electrode layers and one of the resistance layers. A second mechanical dicing operation is performed on the strip structures to dice the electrode layer on each of the strip structures into a first electrode and a second electrode. A third mechanical dicing operation is performed on each of the strip structures to separate each of the strip structures into plural shunt resistors. A trimming operation is performed on each of the shunt resistors.

According to one embodiment of the present disclosure, performing the electroplating operation includes using a rack plating method.

According to one embodiment of the present disclosure, a thickness of the electrode material layer is ranging from 75 μm to 200 μm.

According to one embodiment of the present disclosure, a dicing depth of the second mechanical dicing operation is ranging from a thickness of the electrode material layer to the thickness +50 μm.

According to one embodiment of the present disclosure, performing the first mechanical dicing operation, the second mechanical dicing operation, and the third mechanical dicing operation includes using a dicing blade or a computer numerically controlled (CNC) milling cutter.

According to one embodiment of the present disclosure, performing the trimming operation includes using a mechanical processing equipment capable of measuring electrical properties. Performing the trimming operation includes using a dicing method that uses a probe type dicing blade, a dicing method that uses a probe type computer numerically controlled milling cutter, or a probe type computer numerically controlled drilling method.

According to one embodiment of the present disclosure, the insulating carrier film is a thermal release film or an ultraviolet (UV) release film. Performing the first mechanical dicing operation includes exposing the insulating carrier film but not dicing off the insulating carrier film.

According to one embodiment of the present disclosure, after performing the trimming operation, the method further includes removing the insulating carrier film.

According to one embodiment of the present disclosure, a material of the insulating carrier film is FR4 or polyimide (PI). Performing the first mechanical dicing operation includes exposing the insulating carrier film but not dicing off the insulating carrier film.

According to one embodiment of the present disclosure, after performing the trimming operation, the method further includes forming an insulating protective layer on the resistance layer between the first electrode and the second electrode of each of the shunt resistors; and performing a fourth mechanical dicing operation to dice the insulating carrier film to separate the shunt resistors.

According to one embodiment of the present disclosure, after performing the fourth mechanical dicing operation, the method further includes performing an electroplating process on each of the shunt resistors to form a first terminal electrode and a second terminal electrode on each of the shunt resistors, in which the first terminal electrode covers the first electrode and the resistance layer underlying the first electrode, and the second terminal electrode covers the second electrode and the resistance layer underlying the second electrode.

According to one embodiment of the present disclosure, forming each of the first terminal electrode and the second terminal electrode of each of the shunt resistors includes forming a copper layer, forming a nickel layer to cover the copper layer, and forming a tin layer to cover the nickel layer. The copper layer is higher than the insulating protective layer, and a height difference between the copper layer and the insulating protective layer is equal to or greater than 5 μm.

The embodiments of the present disclosure use an electroplating method to form an electrode material layer on a resistance piece, and use a mechanical dicing method to define a shape of a shunt resistor and two electrodes of the shunt resistor. Therefore, the method of the present disclosure can prevent the resistance value drift resulted from the thermal effect of the welding surface between the resistor and the electrodes caused by the traditional thermal welding technology, and the inability to achieve miniaturization due to the limitation of the welding width. In addition, the method of the present disclosure can solve the problem that the traditional manufacturing process requires a large-scale welding or cold-pressure welding apparatus, such that it can achieve the production of miniaturized shunt resistors without investing in large production apparatus costs.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 through FIG. 5 are three-dimensional schematic diagrams of various intermediate stages in a method for manufacturing a shunt resistor in accordance with one embodiment of the present disclosure.

FIG. 6A is a three-dimensional schematic diagram of an intermediate stage in a method for manufacturing a shunt resistor in accordance with one embodiment of the present disclosure.

FIG. 6B is a schematic cross-sectional view of the shunt resistor in FIG. 6A.

FIG. 7 is a three-dimensional schematic diagram of an intermediate stage in a method for manufacturing a shunt resistor in accordance with one embodiment of the present disclosure.

FIG. 8 through FIG. 11 are three-dimensional schematic diagrams of various intermediate stages in a method for manufacturing a shunt resistor in accordance with another embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms "first", "second", and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms "connected", "electrically connected", or the like between two components referred to in the present disclosure are not limited to the direct connection or electrical connection of the two components, and may also include indirect connection or electrical connection as required.

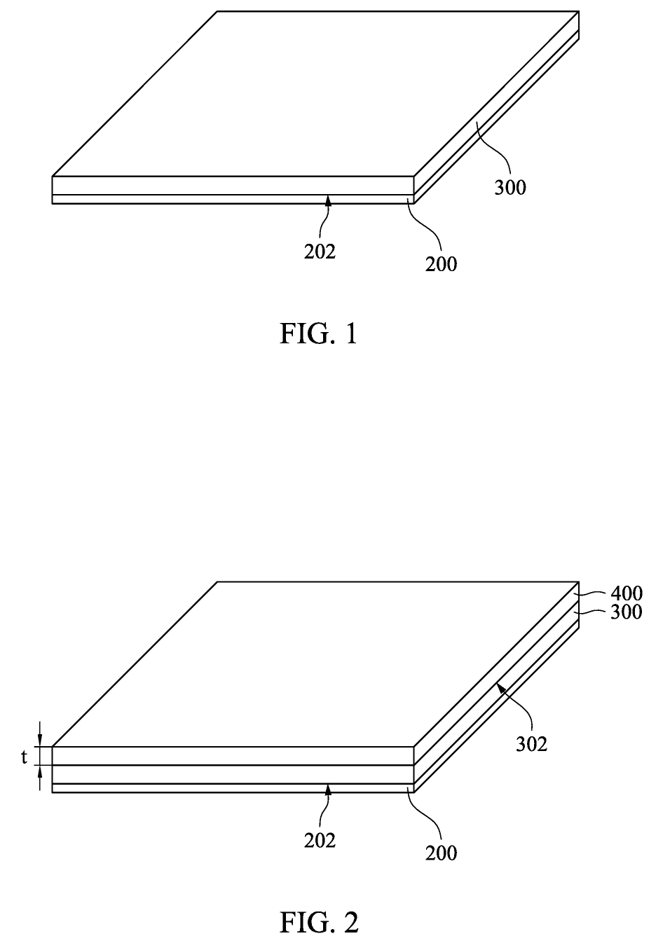

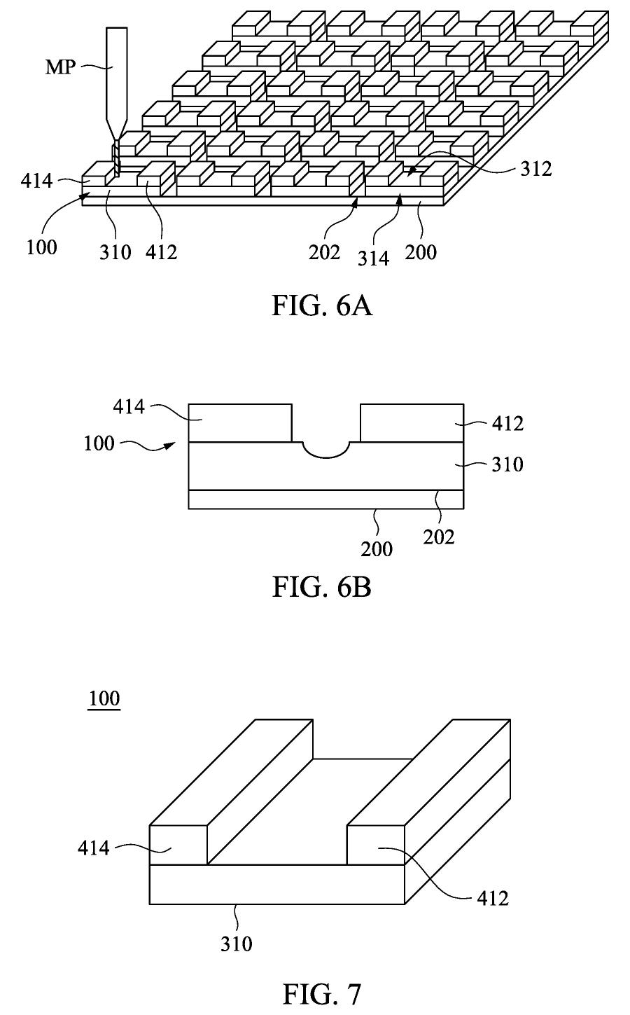

Referring to FIG. 1 through FIG. 5, FIG. 6A, and FIG. 7, FIG. 1 through FIG. 5, FIG. 6A, and FIG. 7 are three-dimensional schematic diagrams of various intermediate stages in a method for manufacturing a shunt resistor 100 in accordance with one embodiment of the present disclosure. In the present disclosure, in the manufacturing of the shunt resistor 100 as shown in FIG. 7, an insulating carrier film 200 and a resistance piece 300 may be first provided, and then the resistance piece 300 is attached to a surface 202 of the insulating carrier film 200, as shown in FIG. 1. The insulating carrier film 200 is a removable film with adhesive on one side. The insulating carrier film 200 may be a thermal release film or an ultraviolet release film, and the viscosity of the insulating carrier film 200 can be decreased by heating or irradiating ultraviolet light. However, the insulating carrier film 200 may be any release film that can be removed by processing, and the present embodiment is not limited thereto. The resistance piece 300 may be a metal alloy piece. For example, a material of the resistance piece 300 may be a copper-manganese alloy, a copper-nickel alloy, a copper-manganese-nickel alloy, a copper-manganese-tin alloy, a nickel-chromium-aluminum alloy, a nickel-chromium-aluminum-silicon alloy, or an iron-chromium-aluminum alloy. However, the material of the resistance piece 300 may be other suitable resistance materials, and the present disclosure is not limited thereto.

As shown in FIG. 2, after the resistance piece 300 is attached to the insulating carrier film 200, an electroplating operation may be performed to form an electrode material layer 400 on a surface 302 of the resistance piece 300. In some examples, the electroplating operation is performed by a rack plating method, such that the electrode material layer 400 is only plated on the surface 302 of the resistance piece 300. The electrode material layer 400 can be evenly plated on the surface 302 of the resistance piece 300 through the electroplating operation. A material of the electrode material layer 400 may be copper, for example. In some exemplary examples, a thickness t of the electrode material layer 400 is substantially ranging from 75 μm to 200 μm. When the thickness t of the electrode material layer 400 is equal to or greater than 75 μm, the resistance of the electrode material layer 400 is too small to affect the resistance of the shunt resistor 100. When the thickness t of the electrode material layer 400 is greater than 200 μm, it is difficult to dice the electrode material layer 400.

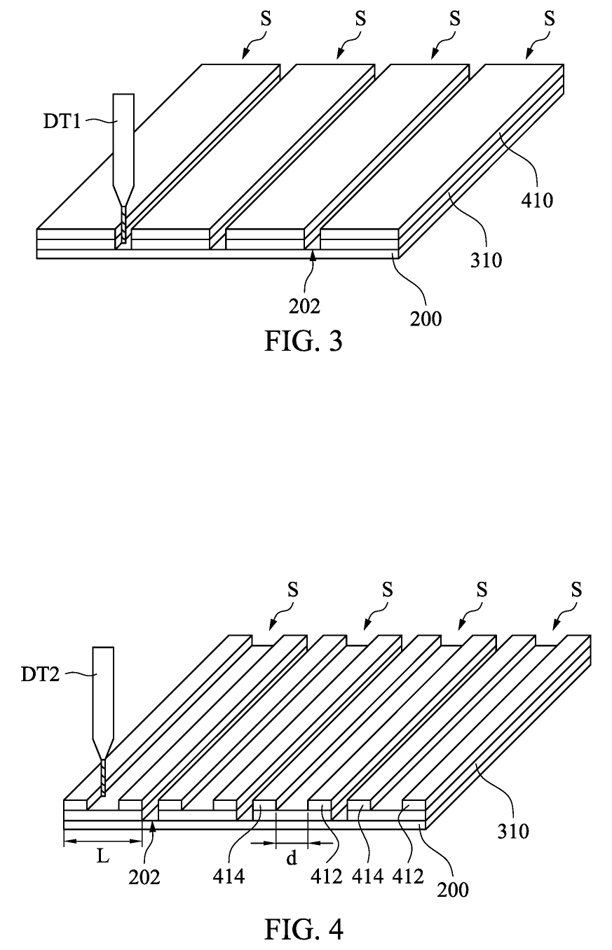

Next, as shown in FIG. 3, a first mechanical dicing operation may be performed on the electrode material layer 400 and the resistance piece 300 by using a dicing tool DT1 to remove a portion of the electrode material layer 400 and a portion of the resistance piece 300 to define a length L of the shunt resistor 100. The length L of the shunt resistor 100 can be defined according to product specifications. For example, the length L of the shunt resistor 100 of type SMD 0402 is 1.0 mm. In the first mechanical dicing operation, the electrode material layer 400 and the resistance piece 300 can be respectively divided into plural electrode layers 410 and plural resistance layers 310 to form plural strip structures S. Each of the strip structures S includes one of the resistance layers 310 and one of the electrode layers 410 stacked on the resistance layer 310. The first mechanical dicing operation can expose the surface 202 of the insulating carrier film 200 without dicing off the insulating carrier film 200. In some examples, the dicing tool DT1 is a dicing blade or a computer numerically controlled milling cutter.

As shown in FIG. 4, after completing the definition of the length L of the shunt resistor 100, a second mechanical dicing operation may be performed on the strip structures S by using a dicing tool DT2 to define electrodes, such that the electrode layer 410 on each of the strip structures S is divided into a first electrode 412 and a second electrode 414. The first electrode 412 and the second electrode 414 on each of the strip structures S are separated from each other by a distance d. The distance d is defined according to product specifications. For example, in the shunt resistor 100 of type SMD 0402, the distance d between the first electrode 412 and the second electrode 414 may be 0.5 mm. In some examples, a dicing depth of the second mechanical dicing operation ranges from the thickness t of the electrode material layer 400 to the thickness t+50 μm, such that the electrode material layer 400 in the distance d is completely removed. Similarly, the dicing tool DT2 may be a cutting blade or a computer numerically controlled milling cutter. The dicing tool DT2 may be the same as or different from the dicing tool DT1.

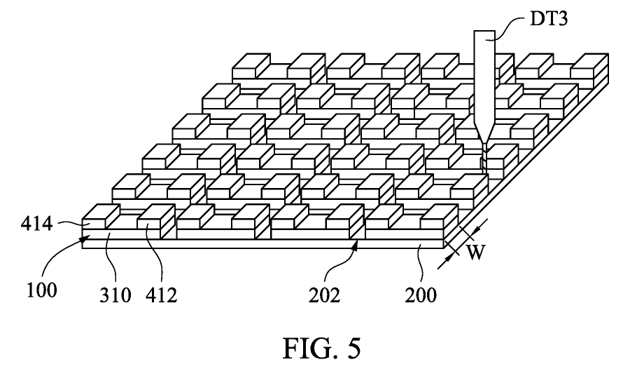

Then, as shown in FIG. 5, a third mechanical dicing operation may be performed on each of the strip structures S to define a width W of the shunt resistor 100 by using a dicing tool DT3. The width W of the shunt resistor 100 is defined according to product specifications. For example, the width W of the shunt resistor 100 of type SMD 0402 is 0.5 mm. The third mechanical dicing operation can simultaneously dice the first electrode 412, the second electrode 414, and the resistance layer 310 on each of the strip structures S, but does not dice off the insulating carrier film 200. The third mechanical dicing operation can divide each of the strip structures S into plural pelleted shunt resistors 100. The dicing tool DT3 may be a dicing blade or a computer numerically controlled milling cutter. The third mechanical dicing operation can expose the surface 202 of the insulating carrier film 200 without dicing off the insulating carrier film 200. The dicing tools DT3, DT1, and DT2 may be the same as or different from each other, or two of the dicing tools DT3, DT1, and DT2 are the same but the other one is different.

Subsequently, as shown in FIG. 6A, a trimming operation may be selectively performed on each of the shunt resistors 100 by using a mechanical processing equipment MP according to product requirements. Referring to FIG. 6B, FIG. 6B is a schematic cross-sectional view of the shunt resistor 100 in FIG. 6A. In some examples, the shunt resistor 100 is trimmed by using the mechanical processing equipment MP capable of measuring electrical properties to remove a portion of the resistance layer 310, such that the shunt resistor 100 can have a preset resistance value. For example, the mechanical processing equipment MP may be a probe type dicing blade, a probe type computer numerically controlled milling cutter, or a probe type computer numerically controlled drilling machine. In some exemplary examples, the resistance layer 310 between the first electrode 412 and the second electrode 414 of each of the shunt resistors 100 is precisely processed by using a dicing method that uses a probe type dicing blade, a dicing method that uses a probe type computer numerically controlled milling cutter, or a probe type computer numerically controlled drilling method, such that each of the shunt resistors 100 has a preset resistance value.

In the present embodiment, after the trimming of the shunt resistor 100 is completed, the insulating carrier film 200 can be removed to complete the manufacturing of the shunt resistors 100, as shown in FIG. 7. In the example where the insulating carrier film 200 is a thermal release film, the viscosity of the insulating carrier film 200 can be decreased by heating to facilitate the separation of the shunt resistor 100 from the insulating carrier film 200. In the example where the insulating carrier film 200 is an ultraviolet release film, the insulating carrier film 200 can be irradiated by using an ultraviolet light, such that the insulating carrier film 200 can be separated from the shunt resistor 100.

In the present embodiment, the electroplating method is used to form the electrode material layer 400 on the resistance piece 300, and the mechanical dicing method is used to define the shape of the shunt resistor 100, and the first electrode 412 and the second electrode 414 of the shunt resistor 100. Therefore, the present embodiment can prevent the resistance value drift caused by the welding thermal effect and is not limited by the welding width, thereby achieving miniaturization of the shunt resistor 100. In addition, the present embodiment does not require a large investment in production apparatus costs, thereby significantly reducing production costs.

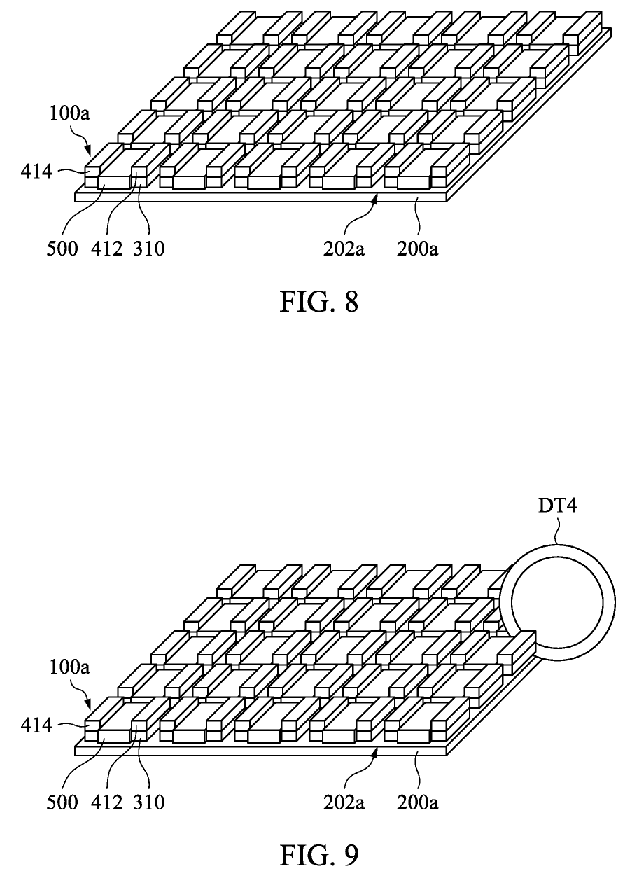

Referring to FIG. 8 through FIG. 11, FIG. 8 through FIG. 11 are three-dimensional schematic diagrams of various intermediate stages in a method for manufacturing a shunt resistor 100a in accordance with another embodiment of the present disclosure. In the present embodiment, a front-end process of manufacturing the shunt resistor 100a shown in FIG. 11 is substantially the same as the process shown in FIG. 1 through FIG. 6A. Therefore, the parts of the front-end process of the shunt resistor 100a that the same as those of the process shown in FIG. 1 to FIG. 6A will not be repeated here.

The difference between the front-end process of the shunt resistor 100a and the process of FIG. 1 to FIG. 6A is that the resistance piece 300 is bonded to a surface 202a of a non-removable insulating carrier film 200a. For example, a material of the insulating carrier film 200a may be FR4 or polyimide.

Next, the electrode material layer 400 is similarly formed by using an electroplating method, such as a rack plating method, and the electrode material layer 400 is evenly plated on the surface 302 of the resistance piece 300. Then, a first mechanical dicing operation is performed to define a length of the shunt resistor 100a, such that plural strip structures S are formed. A second mechanical dicing operation is performed to define the first electrode 412 and the second electrode 414 of the shunt resistor 100a. Subsequently, a third mechanical dicing operation is performed to divide each of the strip structures S into plural pelleted shunt resistors 100a. The first mechanical dicing operation and the third mechanical dicing operation are performed to expose the surface 202a of the insulating carrier film 200a, but the insulating carrier film 200a is not diced off. Subsequently, according to product requirements, a trimming operation is selectively performed on each of the shunt resistors 100a to remove a portion of the resistance layer 310, such that each of the shunt resistors 100a can have a preset resistance value.

In the present embodiment, after the trimming operation of the shunt resistor 100a is completed, as shown in FIG. 8, an insulating protective layer 500 is formed on the resistance layer 310 between the first electrode 412 and the second electrode 414 of each of the shunt resistors 100a by using, for example, a printing method or a photolithography method. Specifically, referring to FIG. 6A and FIG. 8 simultaneously, the insulating protective layer 500 covers a top surface 312 and two opposite side surfaces 314 of the resistance layer 310 exposed between the first electrode 412 and the second electrode 414. For example, a material of the insulating protective layer 500 may be epoxy, resin, or polyimide.

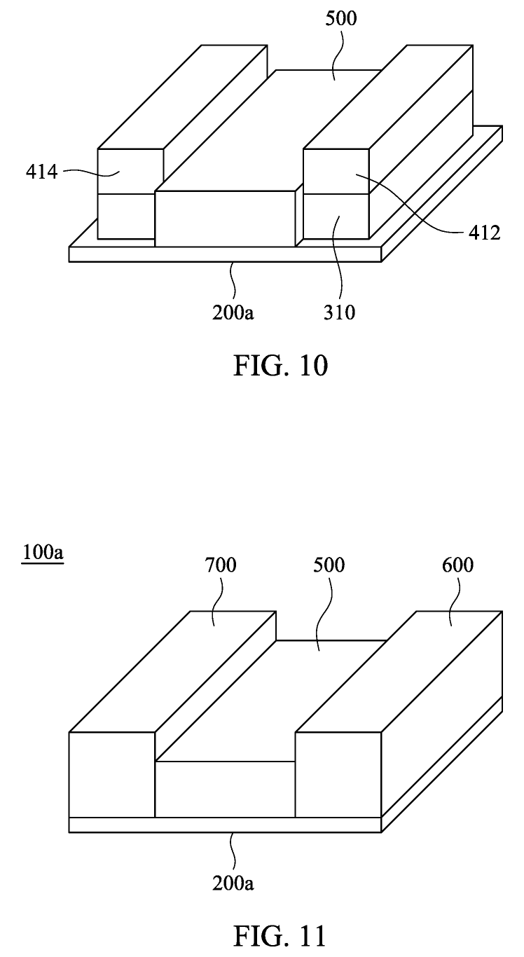

Next, as shown in FIG. 9, a fourth mechanical dicing operation may be performed to dice the insulating carrier film 200a to separate the shunt resistors 100a by using a dicing tool DT4. For example, the dicing tool DT4 may be a dicing blade. As shown in FIG. 10, after the fourth mechanical dicing operation, individual shunt resistors 100a can be formed.

As shown in FIG. 11, after the fourth mechanical dicing operation, an electroplating process may be performed on each of the shunt resistors 100a to form a first terminal electrode 600 covering the first electrode 412 and the resistance layer 310 underlying the first electrode 412, and a second terminal electrode 700 covering the second electrode 414 and the resistance layer 310 underlying the second electrode 414 on each of the shunt resistors 100a. Thus, the structure of the shunt resistor 100a can be applied to flip-chip bonding. The first terminal electrode 600 and the second terminal electrode 700 may be formed simultaneously. Each of the first terminal electrode 600 and the second terminal electrode 700 may be a multi-layer stacked structure. For example, in the forming the first terminal electrode 600 and the second terminal electrode 700, a copper layer may be formed first, a nickel layer may be formed to cover the copper layer, and then a tin layer may be formed to cover the nickel layer. The first terminal electrode 600 can be electroplated based on the first electrode 412 and the underlying resistance layer 310, and the second terminal electrode 700 can be electroplated based on the second electrode 414 and the underlying resistance layer 310. The nickel layer is electroplated based on the copper layer, and the tin layer is electroplated based on the nickel layer.

The copper layer in each of the first terminal electrode 600 and the second terminal electrode 700 is higher than the insulating protective layer 500. In some exemplary examples, a height difference between the copper layer and the insulating protective layer 500 is equal to or greater than 5 μm. This can prevent the connection between the shunt resistor 100a and an external circuit board from being affected when the excessive solder paste enters a space between the insulating protective layer 500 and the circuit board.

It can be known from the above embodiments that the present disclosure uses an electroplating method to form an electrode material layer on a resistance piece, and uses a mechanical dicing method to define a shape of a shunt resistor and two electrodes of the shunt resistor. Therefore, the embodiments of the present disclosure can prevent the resistance value drift resulted from the thermal effect of the welding surface between the resistor and the electrodes caused by the traditional thermal welding technology, and the inability to achieve miniaturization due to the limitation of the welding width. In addition, the embodiments of the present disclosure can solve the problem that the traditional manufacturing process requires a large-scale welding or cold-pressure welding apparatus, such that it can achieve the production of miniaturized shunt resistors without investing in large production apparatus costs.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. A method for manufacturing a shunt resistor, comprising:
attaching a resistance piece to an insulating carrier film;
performing an electroplating operation to form an electrode material layer on a surface of the resistance piece;
performing a first mechanical dicing operation to respectively dice the electrode material layer and the resistance piece into a plurality of electrode layers and a plurality of resistance layers to form a plurality of strip structures, wherein each of the strip structures comprises one of the electrode layers and one of the resistance layers;
performing a second mechanical dicing operation on the strip structures to dice the electrode layer on each of the strip structures into a first electrode and a second electrode;
performing a third mechanical dicing operation on each of the strip structures to separate each of the strip structures into a plurality of shunt resistors; and
performing a trimming operation on each of the shunt resistors.

2. The method for manufacturing a shunt resistor of claim 1, wherein performing the electroplating operation comprises using a rack plating method.

3. The method for manufacturing a shunt resistor of claim 1, wherein a thickness of the electrode material layer is ranging from 75 μm to 200 μm.

4. The method for manufacturing a shunt resistor of claim 1, wherein a dicing depth of the second mechanical dicing operation is ranging from a thickness of the electrode material layer to the thickness +50 μm.

5. The method for manufacturing a shunt resistor of claim 1, wherein performing the first mechanical dicing operation, the second mechanical dicing operation, and the third mechanical dicing operation comprises using a dicing blade or a computer numerically controlled milling cutter.

6. The method for manufacturing a shunt resistor of claim 1, wherein performing the trimming operation comprises using a mechanical processing equipment capable of measuring electrical properties, and performing the trimming operation comprises using a dicing method that uses a probe type dicing blade, a dicing method that uses a probe type computer numerically controlled milling cutter, or a probe type computer numerically controlled drilling method.

7. The method for manufacturing a shunt resistor of claim 1, wherein the insulating carrier film is a thermal release film or an ultraviolet release film, and performing the first mechanical dicing operation comprises exposing the insulating carrier film but not dicing off the insulating carrier film.

8. The method for manufacturing a shunt resistor of claim 7, further comprising removing the insulating carrier film after performing the trimming operation.

9. The method for manufacturing a shunt resistor of claim 1, wherein a material of the insulating carrier film is FR4 or polyimide, and performing the first mechanical dicing operation comprises exposing the insulating carrier film but not dicing off the insulating carrier film.

10. The method for manufacturing a shunt resistor of claim 9, wherein after performing the trimming operation, the method further comprises:
forming an insulating protective layer on the resistance layer between the first electrode and the second electrode of each of the shunt resistors; and
performing a fourth mechanical dicing operation to dice the insulating carrier film to separate the shunt resistors.

11. The method for manufacturing a shunt resistor of claim 10, wherein after performing the fourth mechanical dicing operation, the method further comprises performing an electroplating process on each of the shunt resistors to form a first terminal electrode and a second terminal electrode on each of the shunt resistors, wherein the first terminal electrode covers the first electrode and the resistance layer underlying the first electrode, and the second terminal electrode covers the second electrode and the resistance layer underlying the second electrode.

12. The method for manufacturing a shunt resistor of claim 11, wherein forming each of the first terminal electrode and the second terminal electrode of each of the shunt resistors comprises:
forming a copper layer;
forming a nickel layer to cover the copper layer; and
forming a tin layer to cover the nickel layer,
wherein the copper layer is higher than the insulating protective layer, and a height difference between the copper layer and the insulating protective layer is equal to or greater than 5 μm.
